(19) United States
(12) Patent Application Publication
(10) Pub. No.: US 2007/0109226 A1
(43) Pub. Date: May 17, 2007

(54) Driving method of plasma display panel

(76) Inventor: Eun-Ra Lee, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/541,095

(22) Filed: Sep. 28, 2006

(30) Foreign Application Priority Data
Nov. 15, 2005 (KR) 10-2005-0108934

(51) Int. Cl. G09G 3/28

(52) U.S. Cl. 345/67

(57) ABSTRACT

A method for driving a plasma display panel, which is capable of uniformly performing a sustain discharge in upper and lower portions of the plasma display panel is disclosed. The method includes dividing discharge cells into a plurality of groups and driving the discharge cells for each group. A frame is divided into a reset period, a mixing driving period for performing addressing for each group and for performing sustain discharge operations, and a correction sustain period for correcting the number of sustain discharge operations.

### CROSS-REFERENCE TO RELATED PATENT APPLICATIONS

This application claims priority to and the benefit of Korean Patent Application No. 10-2005-0108934, filed on Nov. 15, 2005, which is hereby incorporated by reference in its entirety.

### BACKGROUND OF THE INVENTION

1. Field of the Invention

The present invention relates to a driving method of a plasma display panel, and more particularly, to a driving method of a plasma display panel, which is capable of uniformly performing in upper and lower portions of the plasma display panel.

2. Description of the Related Technology

Recently, plasma display panels (PDPs) have come to the attention of the public, as substitutes of conventional cathode ray tubes (CRTs). In a plasma display panel, a discharge gas is filled between two substrates on which a plurality of electrodes are formed, a discharge voltage is applied to the electrodes, and phosphor, formed with a predetermined pattern is excited due to ultraviolet rays generated by the discharge voltage, thereby displaying a desired image.

FIG. 1 is a diagram illustrating a conventional address display separation (ADS) driving method which is applied to scan electrodes.

Referring to FIG. 1, a unit frame is divided into a predetermined number of sub-fields, for example, 8 sub-fields SF1 through SF8 for time-division gray-scale display. Also, the sub-fields SF1 through SF8 are divided into reset periods (not shown), address periods A1 through A8, and discharge sustain periods S1 through S8, respectively.

In the reset period, all discharge cells are initialized. In the respective addressing periods A1 through A8, addressing is sequentially performed from the upper portion of a plasma display panel toward the lower portion thereof. In the respective sustain periods S1 through S8, sustain discharges are performed in discharge cells to be turned on, selected in the address periods A1 through A8.

Accordingly, brightness of the plasma display panel is proportional to the total number of sustain discharge operations within the discharge sustain periods S1 through S8 included in a unit frame. If a frame forming an image consists of 8 sub-fields with 256 gray-scales, different gray scale weights of 1, 2, 4, 8, 16, 32, 64 and 128 can be allocated to the respective sub-fields in this order. In this case, in order to obtain brightness with 133 gray-scales, it is needed to address and sustain-discharge cells during a first sub-field period SF1, a third sub-field period SF3, and an eighth sub-field period SF8.

The number of the gray-scale weights allocated to each of the sub-fields can be set according to weight values of sub-fields on the basis of APC (Automatic Power Control). Also, the number of the gray-scale weights allocated to each of the sub-fields can be changed variously in consideration of panel characteristics.

FIG. 2 is a timing diagram of an example of conventional driving signals for driving a 3-electrode plasma display panel. Referring to FIG. 2, a sub-field SF includes a reset period PR, an address period PA and a sustain discharge period PS.

First, in the reset period PR, a rising ramp pulse and a falling ramp pulse are applied to scan electrodes and a bias voltage Vb1 is applied to sustain electrodes from when the falling ramp pulse is applied, so that a reset discharge is performed in discharge cells. Due to the reset discharge, the state of wall charges in the entire discharge cells is initialized.

Then, in the address period PA, a scan pulse Vsc11 is sequentially applied to the scan electrodes from the upper portion of the plasma display panel toward the lower portion thereof, and a display data signal Va1 is applied to address electrodes in synchronization with the scan pulse so that an address discharge is performed in discharge cells to be turned on. After the address discharge is performed, the state of wall charges in the discharge cells is set to be suitable to be subjected to a sustain discharge in the following sustain discharge period PS.

Successively, in the sustain period PS, a sustain pulse Vs1 is alternately applied to the scan electrodes and the sustain electrodes so that sustain discharge operations are performed according to a gray-scale weight corresponding to input data.

According to the conventional plasma display panel driving method as described above, the delay between the end of the address discharge and the beginning of the sustain discharge is shorter in the lower portion of the display than in the upper portion of the display. As a result, the sustain discharge characteristic or intensity of sustain discharge light varies between the upper and lower portions of the plasma display panel. Accordingly, a sustain discharge cannot be uniformly performed. Particularly, this problem is more significant when a high-definition plasma display panel is driven.

### SUMMARY OF CERTAIN INVENTIVE ASPECTS

The present invention provides a driving method of a plasma display panel, which is capable of uniformly performing a sustain discharge in upper and lower portions of the plasma display panel.

One embodiment is a method of driving a plasma display panel, the plasma display panel including sustain electrodes, scan electrodes and address electrodes, the sustain electrodes and the scan electrodes being separated and extending substantially parallel to each other, the address electrodes intersecting the sustain electrodes and the scan electrodes, where discharge cells are defined near where the sustain electrodes intersect the scan electrodes, the discharge cells being divided into a plurality of groups. The method includes driving the discharge cells of each group during a unit frame, divided into a plurality of sub-fields, where each of the sub-fields is divided into a reset period, a mixing driving period, and a correction sustain period, driving the discharge cells for each group during the reset period so as to initialize the discharge cells, driving the discharge cells for each group during the mixing driving period so as to select certain discharge cells of each group and to perform at least one discharge operation for one or more of the plurality of groups, and driving the discharge cells for each group during the correction sustain period so as to correct the number of sustain discharge operations for each group so that a total number of sustain discharge operations corresponding to a gray scale weight determined for each sub-field is performed during each sub-field. The correction sustain period is divided into a selection sustain period and a common sustain period and a sustain discharge in each group is performed during the selection sustain period and the same number of sustain discharge operations for each of plurality of groups is performed during the common sustain period.

Another embodiment is a method of driving a plasma display panel, the plasma display panel including an array of discharge cells, the discharge cells being divided into a plurality of groups. The method includes driving the plurality of groups during a sub-field, the sub-field including a mixing driving period, and driving the plurality of groups during the mixing driving period so as to sequentially select certain discharge cells of a first group, perform at least one discharge operation for the selected cells of the first group, and select certain discharge cells of a second group.

### BRIEF DESCRIPTION OF THE DRAWINGS

The above and other features and advantages of the present invention will become more apparent through the description of embodiments thereof with reference to the attached drawings in which:

FIG. 1 is a view for explaining a conventional address display separation (ADS) driving method which is applied to scan electrodes;

FIG. 2 is a timing diagram of an example of conventional driving signals for driving a 3-electrode plasma display panel;

FIG. 3 illustrates an electrode arrangement of a plasma display panel to which a plasma display panel driving method can be applied;

FIG. 4 is a diagram illustrating an address display mixing (ADM) driving method according to an embodiment;

FIG. 5 is a diagram illustrating a driving operation of a first sub-field SF1 illustrated in FIG. 4;

FIG. 6 is a diagram illustrating a driving operation of a fourth sub-field SF4 illustrated in FIG. 4;

FIG. 7 is a timing diagram of driving signals in the fourth sub-field SF4 illustrated in FIG. 6, according to an embodiment;

FIG. 8 is a timing diagram illustrating driving signals in a correction sustain period C4 illustrated in FIG. 7;

FIG. 9 is a timing diagram of driving signals in the fourth sub-field SF4 illustrated in FIG. 6, according to another embodiment; and

FIG. 10 is a timing diagram illustrating driving signals in a correction sustain period C4 illustrated in FIG. 9.

### DETAILED DESCRIPTION OF CERTAIN INVENTIVE ASPECTS

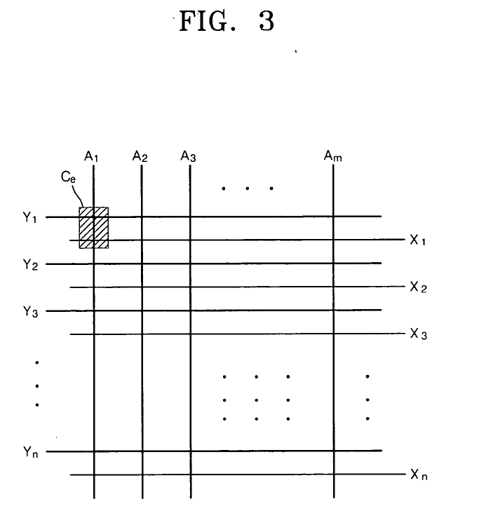

FIG. 3 illustrates an electrode arrangement of a plasma display panel to which a plasma display panel driving method discussed herein can be applied.

Referring to FIG. 3, scan electrodes Y₁, . . . , Yₙ and sustain electrodes X₁, . . . , Xₙ extend parallel to each other, and address electrodes A₁, . . . , Aₘ intersect the scan electrodes Y₁, . . . , Yₙ and the sustain electrodes X₁, . . . , Xₙ. Discharge cells are defined where the scan electrodes Y₁, . . . , Yₙ, the sustain electrodes X₁, . . . , Xₙ, and the address electrodes A₁, . . . , Aₘ intersect to each other.

Hereinafter, Japanese Laid-open Application No. 1999-120924 disclosing an example of a plasma display panel will be described. Referring to the disclosure, the plasma display panel includes address electrodes, dielectric layers, scan electrodes, sustain electrodes, phosphor layers, barrier ribs, and a MgO protection layer, between a front substrate and a rear substrate.

The address electrodes are formed in a pattern on the upper surface of the rear substrate. A rear dielectric layer covers the upper surfaces of the address electrodes. The barrier ribs are formed parallel to the address electrodes on the surface of the rear dielectric layer. The barrier ribs partition discharge spaces of the respective discharge cells and prevent optical interferences between the respective discharge cells. The phosphor layers are formed between the barrier ribs on the upper surface of the rear dielectric layer over the address electrodes. Each phosphor layer includes a red-emitting phosphor layer, a green-emitting phosphor layer, and a blue-emitting phosphor layer which are sequentially arranged.

The sustain electrodes and the scan electrodes are formed in a pattern on the rear surface of the front substrate in such a manner as to intersect the address electrodes. Each of the sustain electrodes and the scan electrodes is formed by coupling a transparent electrode line made of a transparent conductive material such as Indium Tin Oxide (ITO) with a metal electrode line (a bus electrode) for increasing conductivity. The front dielectric layer is formed in such a manner as to entirely cover the rear surfaces of the sustain electrodes and the scan electrodes. The protection layer for protecting the plasma display panel from a strong electric field, for example, a MgO layer is entirely formed on the surface of the front dielectric layer. A plasma forming gas is filled in the discharge spaces. The plasma display panel as described above is an example, and the present invention is not limited to this. That is, an arbitrary structure where scan electrodes and sustain electrodes parallel to each other intersect address electrodes is possible.

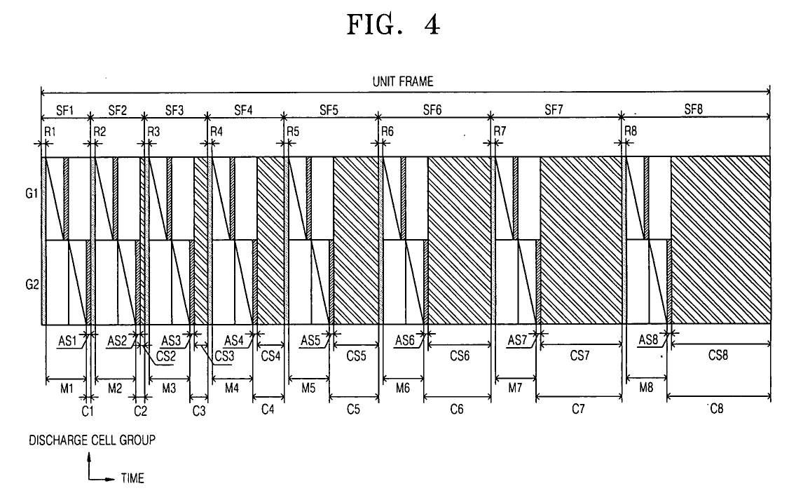

FIG. 4 is a diagram illustrating an address display mixing (ADM) driving method according to an embodiment.

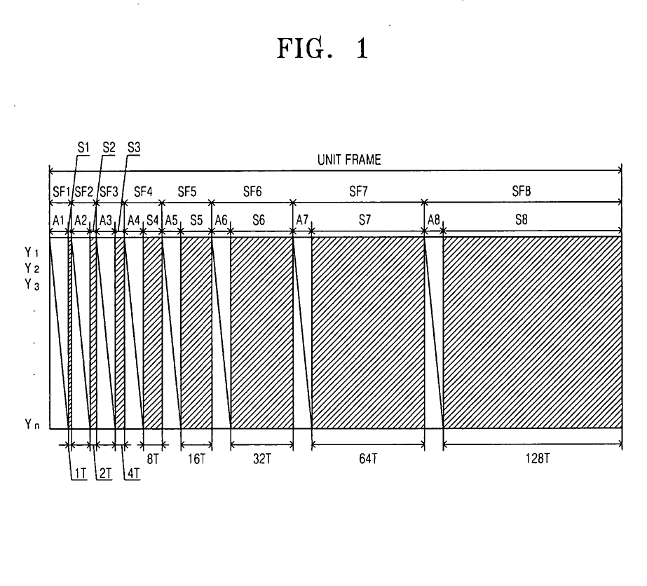

In this embodiment, the plasma display panel is driven using an address display mixing (ADM) driving method, instead of the address display separation (ADS) driving method illustrated in FIG. 1.

Hereinafter, the ADM driving method will be described with reference to FIGS. 3 and 4.

In the ADM driving method, discharge cells are divided into a plurality of groups sequentially from the upper portion of the plasma display panel toward the lower portion thereof, addressing is performed for each group, and a number of sustain discharge operations is performed in groups where addressing has been performed. The ADM driving method is aimed at improving a problem where a sustain discharge is not uniformly performed between the upper and lower portions of a plasma display panel because addressing is performed on the entire plasma display panel in the ADS driving method.

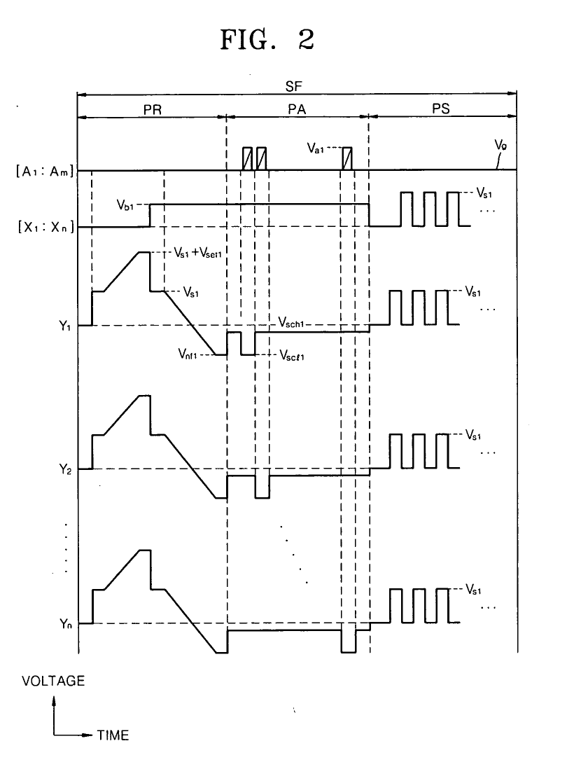

The ADM driving method divides a unit frame into reset periods R1 through R8, mixing driving periods M1 through M8, and correction sustain periods C1 through C8, as shown in FIG. 4. In the reset periods R1 through R8, a reset pulse, such as that shown in FIG. 2, consisting of a rising pulse and a falling pulse is applied to all scan electrodes Y₁, . . . , Yₙ, so that all discharge cells are initialized. Each of the mixing driving periods M1 through M8 is divided into a group address period, during which discharge cells of the group to be turned on are selected, and a group sustain period which occurs between group address periods and performs a number of sustain discharge operations in the selected discharge cells. The correction sustain periods C1 through C8 are divided into selection sustain periods AS1 through AS8 for selectively performing a sustain discharge in the discharge cell groups and for correcting differences in the numbers of sustain discharge operations between respective groups, and common sustain periods CS1 through CS8 for performing sustain discharge operations in such a manner that the number of sustain discharge operations corresponding to a gray scale weight allocated to each sub-field is performed in the sub-field such that the same number of sustain discharge operations are performed for each of the groups.

The plurality of groups can be variously set. For example, the discharge cells can be divided into two groups as illustrated in FIG. 4. Also, the sustain discharge may be once performed in the group sustain period, however, the present invention is not limited to this.

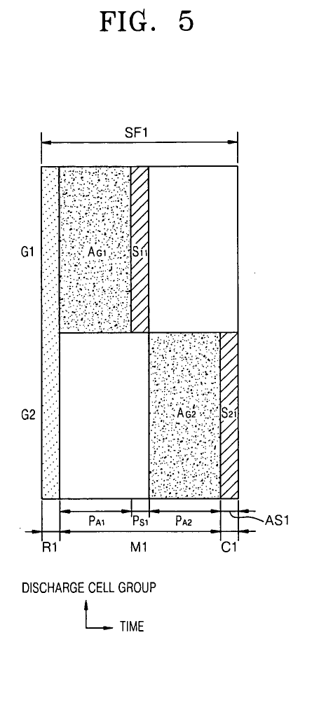

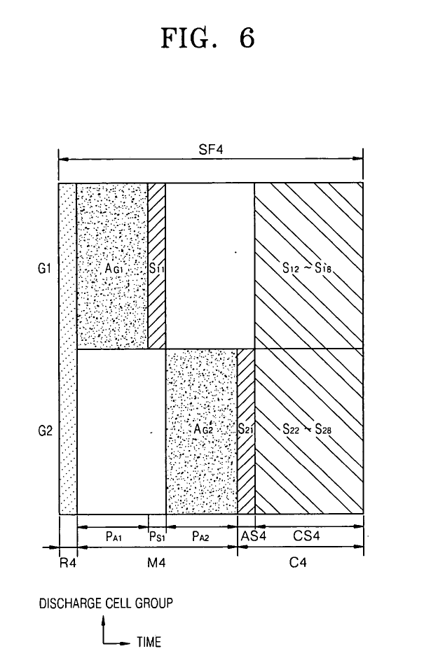

The ADM driving method will be described with reference to FIGS. 5 and 6, below.

FIG. 5 is a diagram illustrating a driving operation of a first sub-field SF1 illustrated in FIG. 4.

First, in a reset period R1, a reset pulse, such as that illustrated in FIG. 2, consisting of a rising pulse and a falling pulse is applied to all scan electrodes and a bias voltage is applied to all sustain electrodes from when the falling pulse is applied, so that a reset discharge is performed. Thus, after the reset period R1 is terminated, the state of wall charges in all discharge cells is uniformly initialized.

Then, in a mixing driving period M1, addressing, that is, an addressing discharge period A_{G1} is performed in a first discharge cell group G1 during a first group address period P_{A1}. Then, in a first group sustain period P_{S1}, a sustain discharge period S₁₁ is performed in the first discharge cell group G1 in which addressing has been performed. Successively, in a second group address period P_{A2}, an address discharge period A_{G2} is performed in a second discharge cell group G2.

Then, in a correction sustain period C1, that is, in a selection sustain period AS1, a sustain discharge period S₂₁ is performed in the second discharge cell group G2 for which addressing has been performed in the second group address period P_{A2}. When a gray scale weight of the first sub-field SF1 is 1, it is sufficient if the sustain discharge is once performed over the first sub-field SF1. However, since the first group sustain period P_{S1} is performed in the first discharge cell group G1 and the selection sustain period AS1 is performed in the second group discharge cell group G2, no common sustain period is needed.

FIG. 6 is a diagram illustrating a driving operation of a fourth sub-field SF4 illustrated in FIG. 4.

First, in a reset period R4, a reset pulse, such as that illustrated in FIG. 2, consisting of a rising pulse and a falling pulse is applied to all the scan electrodes and a bias voltage is applied to all sustain electrodes from when the falling pulse is applied, so that a reset discharge is performed. Thus, the state of wall charges in the entire discharge cells is uniformly initialized.

Then, in a mixing driving period M4, an address discharge period A_{G1} is performed in the first discharge cell group G1 during a first group address period P_{A1}. Then, a sustain discharge period S₁₁ is performed in the first discharge cell group G1 in which addressing has been performed, in a first group sustain period P_{S1}. Subsequently, in a second group address period P_{A2}, an address discharge period A_{G2} is performed in the second discharge cell group G2.

In a correction sustain period C4, during a selection sustain period AS4, a sustain discharge period S₂₁ is performed only in the second discharge cell group G2 for which addressing has been performed in the second group address period P_{A2.} If, for example, a gray scale weight of the fourth sub-field SF4 is 8, a sustain discharge must be performed 8 times for the fourth sub-field SF4. Thus, in a common sustain period CS4, 7 sustain discharge periods S12 through S18 are performed in the first discharge cell group G1, and 7 sustain discharge periods S22 through S28 are performed in the second discharge cell group G2, one sustain discharge having been previously performed in each of the first and second discharge cell groups G1 and G2.

Sub-fields other than the fourth sub-field SF4 are also driven in the same manner as described above.

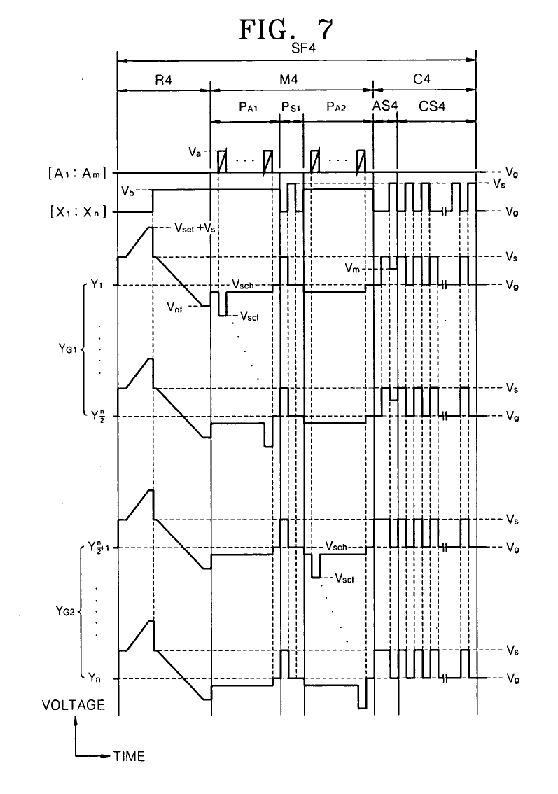

FIG. 7 is a timing diagram of driving signals in the fourth sub-field SF4 illustrated in FIG. 6, according to an embodiment.

In this embodiment, discharge cells are divided into two groups of a first discharge cell group G1 and a second discharge cell group G2, in a up and down direction of a plasma display panel, that is, in a direction in which address electrodes extend. Hereinafter, scan electrodes belonging to the first discharge cell group G1 are referred to as a first scan electrode group Y₁, . . . , Y_{n/2}, and scan electrodes belonging to the second discharge cell group G2 are referred to as a second scan electrode group Y_{n/2+1}, . . . , Yₙ.

First, in a reset period R4, the same reset pulse is applied to all the scan electrodes Y₁, . . . , Yₙ so that wall charges in all the discharge cells are uniformly distributed. Accordingly, a reset pulse consisting of a rising pulse rising by a ninth voltage Vₛₑₜ from a first voltage Vₛ as a sustain discharge voltage and finally reaching a tenth voltage Vₛₑₜ+Vₛ and a falling pulse falling from the first voltage Vₛ and finally reaching an eleventh voltage V_{nf}, is applied to all the scan electrodes Y₁, . . . , Yₙ. A seventh voltage V_{b} which is a bias voltage is applied to all sustain electrodes X₁, . . . , Xₙ from when the falling pulse is applied, and a third voltage V_{g} is applied to all address electrodes A₁, . . . , Aₘ. Here, the seventh voltage V_{b} may be equal to the first voltage Vₛ. In some embodiments, V_{g} is a ground voltage.

In the reset period R4, while the rising pulse is applied, a weak discharge occurs in the discharge cells, negative wall charges are accumulated near the scan electrodes Y₁, . . . , Yₙ, and positive wall charges are accumulated near the sustain electrodes X₁, . . . , Xₘ and the address electrodes A₁, . . . , Aₘ. While the falling pulse is applied, a weak discharge occurs in the discharge cells, the negative wall charges accumulated near the scan electrodes Y₁, . . . , Yₙ are erased, and thus the positive wall charges accumulated near the sustain electrodes X₁, . . . , Xₙ and the address electrodes A₁, . . . , Aₘ are also erased. Accordingly, wall charges in the entire discharge cells are uniformly distributed and initialized.

Then, in a mixing driving period M4, an address discharge and a sustain discharge are both performed.

First, in a first group address period P_{A1}, an address discharge is performed in the first discharge cell group G1. That is, a scan pulse sequentially having a fifth voltage V_{sch} which is a scan high voltage and a sixth voltage V_{sc1} which is a scan low voltage, is applied to the first scan electrode group Y₁, . . . , Y_{n/2}. At this time, a display data signal having an eighth positive voltage Vₐ is applied to the address electrodes A₁, . . . , Aₘ in synchronization with the scan pulse, and a seventh voltage V_{b} is continuously applied to the sustain electrodes X₁, . . . , Xₙ. The seventh voltage V_{b} may be equal to the first voltage Vₛ. By applying the display data signal and the scan pulse, an address discharge is performed between the address electrodes A₁, . . . , Aₘ and the scan electrodes Y₁, . . . , Y_{n/2} in the discharge cells. Accordingly, negative wall charges are accumulated near the sustain electrodes X₁, . . . , Xₙ and positive wall charges are accumulated near the scan electrodes Y₁, . . . , Yₙ. Meanwhile, a third voltage V_{g} is applied to the second scan electrode group Y_{n/2+1}, . . . , Yₙ.

Then, in a first group sustain period P_{S1}, a sustain discharge is performed in the first discharge cell group G1. First, while the first voltage Vₛ and the third voltage V_{g} are sequentially applied to all the scan electrodes Y₁, . . . , Yₙ, the third voltage V_{g} and the first voltage Vₛ are sequentially applied to all the sustain electrodes X₁, . . . , Xₙ.

If the first voltage Vₛ is applied to the scan electrodes Y₁, . . . , Yₙ and the third voltage V_{g} is applied to the sustain electrodes X₁, . . . , Xₙ, since positive wall charges are accumulated near scan electrodes and negative wall charges are accumulated near sustain electrodes, in discharge cells in which an address discharge has been performed, that is, in the first discharge cell group G2 in which an address discharge has been performed in the first group address period P_{A1}, a sustain discharge is performed by the first voltage Vₛ applied to the scan electrodes Y₁, . . . , Yₙ and the third voltage V_{g} applied to the sustain electrodes X₁, . . . , Xₙ.

After the sustain discharge is performed, negative wall charges are accumulated near the scan electrodes and positive wall charges are accumulated near the sustain electrodes. Meanwhile, since no wall charge is accumulated near scan electrodes and sustain electrodes of discharge cells in which no address discharge has been performed, that is, near scan electrodes and sustain electrodes of discharge cells belonging to the second discharge cell group G2, a discharge start voltage is not created and no sustain discharge is performed even when the first voltage Vₛ is applied to the scan electrodes Y₁, . . . , Yₙ and the third voltage V_{g} is applied to the sustain electrodes X₁, . . . , Xₙ. Thus, the state of wall charges in the discharge cells belonging to the second discharge cell group G2 is maintained at the state of wall charges initialized in the reset period R4.

Then, if the third voltage V_{g} is applied to the scan electrodes Y₁, . . . , Yₙ and the first voltage Vₛ is applied to the sustain electrodes X₁, . . . , Xₙ, a sustain discharge is performed in the discharge cells belonging to the first discharge cell group G1. After the sustain discharge is performed, negative wall charges are accumulated near the sustain electrodes and positive wall charges are accumulated near the scan electrodes. Meanwhile, in the discharge cells belonging to the second discharge cell group G2, no sustain discharge is performed even when the third voltage V_{g} and the first voltage Vₛ are respectively applied to the scan electrodes Y₁, . . . , Yₙ and the sustain electrodes X₁, . . . , Xₙ.

The sustain discharge which is performed as described above, includes a sustain discharge in which the first voltage Vₛ is applied to the scan electrodes Y₁, . . . , Yₙ and the third voltage V_{g} is applied to the sustain electrodes X₁, . . . , Xₙ, and a sustain discharge in which the third voltage V_{g} is applied to the scan electrodes Y₁, . . . , Yₙ and the first voltage Vₛ is applied to the sustain electrodes X₁, . . . , Xₙ.

Then, in a second group address period P_{A2}, an address discharge is performed sequentially in the second discharge cell group G2. That is, a scan pulse sequentially having a fifth voltage V_{sch} which is a scan high voltage and a sixth voltage V_{sc1} which is a scan low voltage, is applied to the second scan electrode group Y_{n/2+1}, . . . , Yₙ. At this time, a display data signal having an eighth voltage Vₐ which is an address voltage is applied to the address electrodes A₁, . . . , Aₘ in synchronization with the scan pulse, and a seventh voltage V_{b} is applied to the sustain electrodes X₁, . . . , Xₙ. By applying the display data signal and the scan pulse, an address discharge is performed between the address electrodes A₁, . . . , Aₘ and the scan electrodes Y₁, . . . , Yₙ, so that negative wall charges are accumulated near the sustain electrodes in the discharge cells belonging to the second discharge cell group G2 and positive wall charges are accumulated near the scan electrodes in the discharge cells. Meanwhile, the third voltage V_{g} is applied to the first scan electrode group Y₁, . . . , Y_{n/2}.

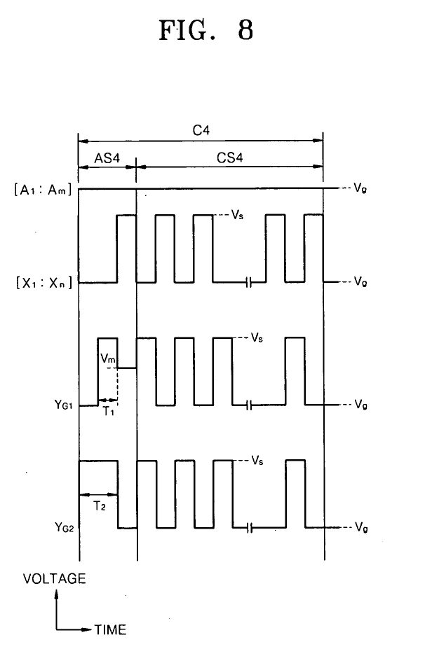

Then, a correction sustain period C4 including a selection sustain period AS4 and a common sustain period CS4 is performed. Referring to FIG. 8, in the selection sustain period AS4, a sustain discharge is selectively performed in the first discharge cell group G1 and the second discharge cell group G2. Since the sustain discharge is once performed in the first discharge cell group G1 and no sustain discharge is performed in the second discharge cell group G2 in the mixing driving period M4, the sustain discharge is selectively performed for each discharge cell group in the selection sustain period AS4. Thus, the first voltage Vₛ and a second voltage Vₘ lower than the first voltage Vₛ are sequentially applied to the first scan electrode group Y₁, . . . , Y_{n/2}, and the first voltage Vₛ and the third voltage V_{g} are sequentially applied to the second scan electrode group Y_{n/2+1}, . . . , Yₙ. In some embodiments, a period T₂ in which the first voltage Vₛ is applied to the second scan electrode group Y_{n/2+1}, . . . , Yₙ is longer than a period T₁ in which the first voltage Vₛ is applied to the first scan electrode group Y₁, . . . , Y_{n/2}. For example, the period T₁ is half of the period T₂. Meanwhile, the third voltage V_{g} and the first voltage Vₛ are sequentially applied to all the sustain electrodes X₁, . . . , Xₙ. As illustrated in the drawing, if the third voltage V_{g} is applied to the sustain electrodes X₁, . . . , Xₙ and the first scan electrode group Y₁, . . . , Y_{n/2} and the first voltage Vₛ is applied to the second scan electrode group Y_{n/2+1}, . . . , Yₙ, no sustain discharge is performed in the discharge cells belonging to the first discharge cell group G1, while a sustain discharge is performed in the discharge cells belonging to the second discharge cell group G2. Thus, in the discharge cells belonging to the first discharge cell group G1, the positive wall charges formed in the first group sustain period P_{A1} are accumulated near scan electrodes and negative wall charges are accumulated near sustain electrodes. In the discharge cells belonging to the second discharge cell group G2, negative wall charges are accumulated near scan electrodes and positive wall charges are formed near sustain electrodes.

Then, when the third voltage V_{g} is applied to the sustain electrodes X₁, . . . , Xₙ, the first voltage Vₛ is applied to the first scan electrode group Y₁, . . . , Y_{n/2}, and the first voltage Vₛ is applied to the second sustain electrode group Y_{n/2+1}, . . . , Yₙ, a sustain discharge is performed in the discharge cells belonging to the first discharge cell group G1. Meanwhile, due to the sustain discharge of the first discharge cell group G1, negative wall charges are accumulated near the scan electrodes of the discharge cells belonging to the first discharge cell group G1 and positive wall charges are accumulated near the sustain electrodes of the discharge cells belonging to the first discharge cell group G1. Meanwhile, since the third voltage V_{g} is continuously applied to the sustain electrodes of the second discharge cell group G2 and the first voltage Vₛ is continuously applied to the scan electrodes of the second discharge cell group G2, more positive wall charges are accumulated in addition to positive wall charges previously accumulated, near the sustain electrodes of the second discharge cell group G2, and more negative wall charges are accumulated in addition to negative wall charges previously accumulated, near the scan electrodes of the second discharge cell group G2.

Then, while the third voltage V_{g} is applied to the sustain electrodes X₁, . . . , Xₙ, a second voltage Vₘ which is an intermediate voltage between the first voltage Vₛ and the third voltage V_{g} is applied to the first scan electrode group Y₁, . . . , Y_{n/2} and the first voltage Vₛ is applied to the second scan electrode group Y_{n/2+1}, . . . , Yₙ. That is, since the second voltage Vₘ lower than the first voltage Vₛ is applied to the first scan electrode group Y₁, . . . , Y_{n/2}, a discharge start voltage is not created and no sustain discharge is performed in the first scan electrode group Y₁, . . . , Y_{n/2}. However, since the first voltage Vₛ is applied to the second scan electrode group Y_{n/2+1}, . . . , Yₙ, a sustain discharge is performed in the second scan electrode group Y_{n/2+1}, . . . , Yₙ. After the selection sustain period AS4 is terminated, more negative wall charges are accumulated in addition to negative wall charges previously accumulated near the scan electrodes and more positive wall charges are accumulated near the sustain electrodes, due to the application of the second positive voltage Vₘ to the scan electrodes. Meanwhile, since the sustain charge is performed in the discharge cells of the second discharge cell group G2, positive wall charges are accumulated near the scan electrodes in the discharge cells and negative wall charge are accumulated near the sustain electrodes in the discharge cells. Here, since the period T₂ in which the first voltage Vₛ was applied to the second discharge cell group G2 is longer than the period T₁ in which the first voltage Vₛ was applied to the first discharge cell group G1, wall charges are further accumulated by the increased amount of wall charges due to the application of the second voltage Vₘ to the first discharge cell group G1.

As a result, the sustain discharge is once performed only in the second discharge cell group G2.

Then, in the common sustain period CS4, a sustain discharge is performed in both the first discharge cell group G1 and the second discharge cell group G2.

The number of total sustain discharge operations occurring before the common sustain period CS4 is 1 for the each of the first discharge cell group G1 and the second discharge cell group G2. If a gray scale weight of the fourth sub-field SF4 is 8, 7 sustain discharge operations must be additionally performed in the common sustain period CS4.

A sustain pulse sequentially having the first voltage Vₛ and the third voltage V_{g} is repeatedly applied to all the scan electrodes Y₁, . . . , Yₙ, and a sustain pulse sequentially having the third voltage V_{g} and the first voltage Vₛ is repeatedly applied to all the sustain electrodes X₁, . . . , Xₙ. The third voltage V_{g} is applied to the address electrodes A₁, . . . , Aₘ.

When the common sustain period CS4 is started, negative wall charges are formed near the scan electrodes of the first discharge cell group G1, positive wall charges are formed near the sustain electrodes of the first discharge cell group G1, positive wall charges are formed near the scan electrodes of the second discharge cell group G2, and negative wall charges are formed near the sustain electrodes of the second discharge cell group G2.

When the first voltage Vₛ is first applied to all the scan electrodes Y₁, . . . , Yₙ in the common sustain period CS4, no sustain discharge is performed in the first discharge cell group G1 and a sustain discharge is performed in the second discharge cell group G2 according to the state of wall charges previously formed in the discharge cells, so that negative wall charges are performed near the scan electrodes of the second discharge cell group G2 and positive wall charges are formed near the sustain electrodes of the second discharge cell group G2. When the third voltage V_{g} is applied to all the scan electrodes Y₁, . . . , Yₙ, a sustain discharge is performed in all the discharge cells in the state where wall charges have been formed. Thereafter, if a sustain pulse is continuously and repeatedly applied, the sustain discharge is repeatedly performed in all the discharge cells.

As illustrated in FIGS. 7 and 8, a sustain discharge period is performed for each discharge cell group just after addressing is performed for each discharge cell group, a wait period between an address discharge and a sustain discharge is reduced compared to the conventional technique. This stabilizes the discharge characteristic of the sustain discharge. Also, when the number of sustain discharge operations is corrected in the correction sustain period C4, the first voltage Vₛ, the first voltage Vₛ, and the third voltage V_{g} are sequentially applied to the scan electrodes of the second discharge cell group G2, while the third voltage V_{g}, the first voltage Vₛ, and the second voltage Vₘ are sequentially applied to the scan electrodes of the first discharge cell group G1. Thus, it is possible to compensate for higher quantities of negative wall charges accumulated near the scan electrodes of the first discharge cell group G1 than near the scan electrodes of the second discharge cell group G2. Accordingly, the sustain discharge is uniformly performed in the common sustain period CS4 so that the brightness of actual sustain light is substantially uniform.

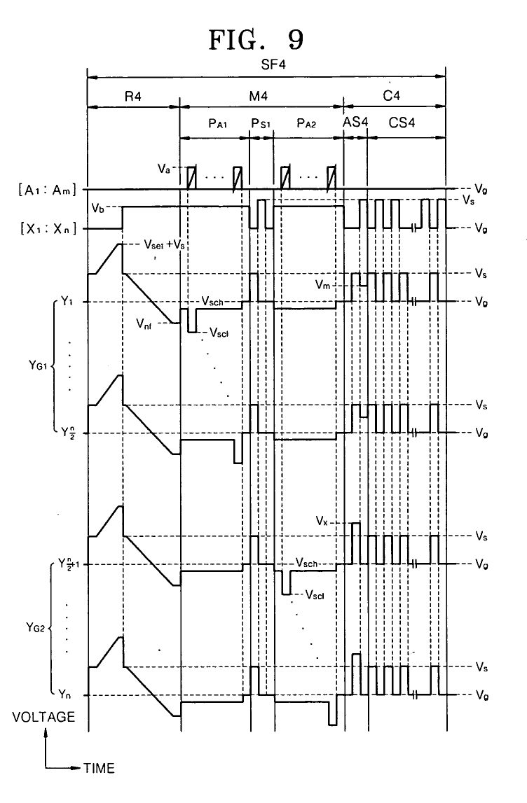

FIG. 9 is a timing diagram of driving signals in the fourth sub-field SF4 illustrated in FIG. 6, according to another embodiment.

The driving signals illustrated in FIG. 9 are similar to the driving signals illustrated in FIG. 7, except for driving signals applied in the correction sustain period C4. Accordingly, a description only regarding the correction sustain period C4 will be given below

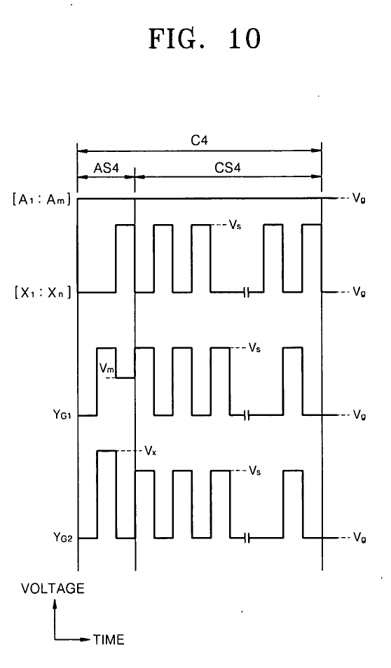

The correction sustain period C4 of FIG. 9 will be described with reference to FIG. 10.

In the embodiment illustrated in FIG. 7, during the selection sustain period AS4 in the correction sustain period C4, a period in which the first voltage Vₛ is applied to the second scan electrode group Y_{n/2+1}, . . . , Yₙ is longer than a period in which the first voltage Vₛ is applied to the first scan electrode group Y₁, . . . , Y_{n/2}. In the embodiment illustrated in FIG. 9, during the selection sustain period AS4 in the correction sustain period C4, a fourth voltage Vₓ higher than the first voltage Vₛ is applied to the second scan electrode group Y_{n/2+1}, . . . , Yₙ while the first voltage Vₛ is applied to the first scan electrode group Y₁, . . . , Y_{n/2}.

That is, in the selection sustain period AS4, the third voltage V_{g}, the fourth voltage Vₓ higher than the first voltage Vₛ, and the third voltage V_{g} are sequentially applied to the second scan electrode group Y_{n/2+1}, . . . , Yₙ, while the third voltage V_{g}, the first voltage Vₛ, and the second voltage Vₘ lower than the first voltage Vₛ are sequentially applied to the first scan electrode group Y₁, . . . , Y_{n/2}. Also, the third voltage V_{g} and the first voltage Vₛ are sequentially applied to all the sustain electrodes X₁, . . . , Xₙ.

Accordingly, in the common sustain period CS4, a sustain discharge is uniformly performed in each of the first discharge cell group G1 and the second discharge cell group G2, so that the brightness of sustain light is substantially uniformly generated.

As described above, according to the present invention, the following effects can be obtained.

First, by grouping pairs of scan electrodes and sustain electrodes defining discharge cells and sequentially performing addressing and a sustain discharge on respective groups, a wait period between an address discharge and a sustain discharge is reduced compared to the conventional ADS technique. This results in more uniform accumulation of wall charges in the discharge cells and better stabilizing of the discharge characteristic of the sustain discharge.

Second, in order to mitigate for a difference in the states and quantity of wall charges between a first discharge cell group and a second discharge cell group caused by a second positive voltage applied to a first scan electrode group, a the sustain discharge for the first discharge cell group is less than the sustain discharge for the second discharge cell group. This is accomplished by, for example, a first positive voltage is applied to a second scan electrode group longer than to the first scan electrode group or a fourth positive voltage higher than the first voltage is applied to the second scan electrode group in a selection sustain period. Accordingly, a sustain discharge can be more uniformly performed.

While the present invention has been particularly shown and described with reference to certain embodiments thereof, it will be understood by those of ordinary skill in the art that various changes in form and details may be made therein without departing from the spirit and scope of the present invention.

What is claimed is:

1. A method of driving a plasma display panel, the plasma display panel including sustain electrodes, scan electrodes and address electrodes, the sustain electrodes and the scan electrodes being separated and extending substantially parallel to each other, the address electrodes intersecting the sustain electrodes and the scan electrodes, wherein discharge cells are defined near where the sustain electrodes intersect the scan electrodes, the discharge cells being divided into a plurality of groups, the method comprising:
driving the discharge cells of each group during a unit frame, divided into a plurality of sub-fields, wherein each of the sub-fields is divided into a reset period, a mixing driving period, and a correction sustain period;
driving the discharge cells for each group during the reset period so as to initialize the discharge cells;
driving the discharge cells for each group during the mixing driving period so as to select certain discharge cells of each group and to perform at least one discharge operation for one or more of the plurality of groups; and
driving the discharge cells for each group during the correction sustain period so as to correct the number of sustain discharge operations for each group so that a total number of sustain discharge operations corresponding to a gray scale weight determined for each sub-field is performed during each sub-field,
wherein the correction sustain period is divided into a selection sustain period and a common sustain period and a sustain discharge in each group is performed during the selection sustain period and the same number of sustain discharge operations for each of plurality of groups is performed during the common sustain period.

2. The method of claim 1, wherein during the selection sustain period, a first voltage with positive polarity and a second voltage lower than the first voltage are sequentially applied to scan electrodes of a first group of the plurality of groups.

3. The method of claim 2, wherein the first voltage and a third voltage lower than the second voltage are sequentially applied to scan electrodes of at least one second group, wherein a duration for which the first voltage is applied to the scan electrodes of the second group is longer than a duration for which the first voltage is applied to the scan electrodes of the first group

4. The method of claim 2, wherein a fourth voltage higher than the first voltage and the third voltage is sequentially applied to the second group of the plurality of groups.

5. The method of claim 3, wherein, in the selection sustain period, the third voltage and the first voltage are sequentially applied to substantially all sustain electrodes of the plurality of groups.

6. The method of claim 3, wherein, in the common sustain period, the first voltage and the third voltage are alternately applied to all the scan electrodes of the plurality of groups, and the third voltage and the first voltage are alternately applied to all the sustain electrodes of the plurality of groups.

7. The method of claim 3, wherein the mixing driving period is divided into a plurality of group address periods, with a group sustain period between the group address periods, and driving the discharge cells for each group during the mixing driving period comprises:
selecting discharge cells for each group during the group address period associated with each group; and
during each group sustain period, performing a sustain discharge operation for the group associated with the immediately preceding group address period.

8. The method of claim 7, wherein, in each of the group address periods, a scan pulse sequentially having a fifth voltage and a sixth voltage lower than the fifth voltage is applied to scan electrodes of each group, a seventh voltage with positive polarity is applied to the sustain electrodes of the plurality of groups, and a display data signal having an eighth voltage with positive polarity is applied to address electrodes of each group in synchronization with the scan pulse.

9. The method of claim 7, wherein, in the group sustain period, the first voltage and the third voltage are sequentially applied to scan electrodes of each group, the third voltage and the first voltage are sequentially applied to sustain electrodes of each group, and the third voltage is continuously applied to address electrodes of each group.

10. The method of claim 3, wherein, in the reset period, a rising pulse rising from the first voltage by a ninth voltage to a tenth voltage, and a falling pulse falling from the first voltage to an eleventh voltage, are applied to scan electrodes of the plurality of groups, a seventh voltage with positive polarity is applied to sustain electrodes of the plurality of groups from when the falling pulse is applied, and the third voltage is continuously applied to the address electrodes.

11. The method of claim 3, wherein the second voltage is a voltage at which no sustain discharge occurs between the sustain electrodes and the scan electrodes of the first group.

12. The method of claim 1, wherein driving the discharge cells for each group during the mixing driving period comprises performing one discharge operation for one or more of the plurality of groups.

13. The method of claim 1, wherein the plurality of groups is 2 groups.

14. The method of claim 1, wherein the third voltage is a ground voltage.

15. The method of claim 1, wherein the groups of discharge cells are divided along one or more lines substantially parallel to the address electrodes.

16. The method of claim 1, wherein during the unit frame a complete image is formed.

17. A method of driving a plasma display panel, the plasma display panel comprising an array of discharge cells, the discharge cells being divided into a plurality of groups, the method comprising:
driving the plurality of groups during a sub-field, the sub-field comprising a mixing driving period; and
driving the plurality of groups during the mixing driving period so as to sequentially:
select certain discharge cells of a first group;
perform at least one discharge operation for the selected cells of the first group; and
select certain discharge cells of a second group.

18. The method of claim 17, wherein the sub-field further comprises a correction sustain period and the method further comprises driving the plurality of groups during the correction sustain period so as to correct the number of sustain discharge operations for each group so that a total number of sustain discharge operations for each group corresponds to a gray scale weight determined for each group is performed during each sub-field.

19. The method of claim 17, wherein the correction sustain period comprises a selection sustain period and a common sustain period and the method further comprises:
performing a sustain discharge for each group during the selection sustain period; and
performing the same number of sustain discharge operations for each of plurality of groups during the common sustain period.

20. The method of claim 19, wherein during the selection sustain period, the sustain discharge for the first group is less than the sustain discharge for the second group.
